(19) United States
(12) Patent Application Publication
(10) Pub. No.: US 2017/0195327 A1
(43) Pub. Date: Jul. 6, 2017

(54) PEER-TO-PEER COMMUNICATION BASED ON DEVICE IDENTIFIERS

(71) Applicants: STRATIO, INC., San Jose, CA (US); STRATIO, Seoul (KR)

(72) Inventors: Jae Hyung LEE, Palo Alto, CA (US); Youngsik Kim, Palo Alto, CA (US); Yeul Na, Los Altos, CA (US); Wooshik Jung, San Jose, CA (US); Seema Bhattiprolu, Mountain View, CA (US)

(21) Appl. No.: 15/468,027

(22) Filed: Mar. 23, 2017

Related U.S. Application Data
(63) Continuation of application No. PCT/US2015/052410, filed on Sep. 25, 2015.
(60) Provisional application No. 62/055,103, filed on Sep. 25, 2014.

(51) Int. Cl. H04L 29/06; G06F 21/44

(52) U.S. Cl. CPC H04L 63/0876; G06F 21/44; H04L 63/104; H04W 12/08

(57) ABSTRACT

A server system receives from a first electronic device a first device identifier and network information of the first electronic device; subsequent to receiving the first device identifier and the network information of the first electronic device, receives from a second electronic device a second device identifier and network information of the second electronic device; in response to receiving from the second electronic device the second device identifier and the network information of the second electronic device, determines whether the first device identifier is associated with the second device identifier; and, in accordance with a determination that the first device identifier is associated with the second device identifier, sends to the second electronic device the network information of the first electronic device and/or sends to the first electronic device the network information of the second electronic device.

### RELATED APPLICATIONS

This application is a continuation application of the International Patent Application Serial No. PCT/US2015/052410, filed Sep. 25, 2015, which claims the benefit of, and priority to, U.S. Provisional Patent Application Ser. No. 62/055,103, filed Sep. 25, 2014, both of which are incorporated by reference herein in their entireties.

### TECHNICAL FIELD

This relates to devices and methods for data communication, and in particulate, to devices and methods for establishing peer-to-peer data communication.

### BACKGROUND

Recently, voice over IP (VoIP) or video call services are gaining significant interests. To enable these services, peer-to-peer connections are often used.

Many VoIP or video call service providers, such as Skype, use personal accounts to identify users and connect them (e.g., establish a peer-to-peer connection). These accounts can be used to manage contact lists, find other users, and pay service fees. For some service providers, users can use existing email accounts or phone numbers for the video call services; however, for many other service providers, users have to create dedicated accounts with passwords, which are cumbersome and time consuming. Out of security concerns, some service providers require complex passwords that are not easy to remember, which impose mental burdens on users. When users forget their passwords, they need to go through a complex password recovery process to reset or retrieve the passwords, which are also cumbersome and time consuming. Some users refrain from using the VoIP or video call services all together because of these challenges and disadvantages.

These challenges and disadvantages are significant impediments to wider adoption of VoIP and video call services.

### SUMMARY

Accordingly, there is a need for more efficient methods and devices for establishing peer-to-peer connections. Such methods and devices optionally complement or replace conventional methods and devices for establishing peer-to-peer connections.

In accordance with some embodiments, a method is performed at a server system that includes one or more processors and memory. The method includes receiving from a first electronic device a first device identifier of the first electronic device and network information of the first electronic device; and, subsequent to receiving from the first electronic device the first device identifier of the first electronic device and the network information of the first electronic device, receiving from a second electronic device, that is distinct from the first electronic device, a second device identifier of the second electronic device and network information of the second electronic device. The second device identifier is distinct from the first device identifier. The method also includes, in response to receiving from the second electronic device the second device identifier of the second electronic device and the network information of the second electronic device, determining whether the first device identifier is associated with the second device identifier; and, in accordance with a determination that the first device identifier is associated with the second device identifier, sending to the second electronic device the network information of the first electronic device and/or sending to the first electronic device the network information of the second electronic device.

In accordance with some embodiments, a server system includes one or more processors and memory storing one or more programs for execution by the one or more processors. The server system receives from a first electronic device a first device identifier of the first electronic device and network information of the first electronic device. Subsequent to receiving from the first electronic device the first device identifier of the first electronic device and the network information of the first electronic device, the server system receives from a second electronic device, that is distinct from the first electronic device, a second device identifier of the second electronic device and network information of the second electronic device. The second device identifier is distinct from the first device identifier. In response to receiving from the second electronic device the second device identifier of the second electronic device and the network information of the second electronic device, the server system determines whether the first device identifier is associated with the second device identifier. In accordance with a determination that the first device identifier is associated with the second device identifier, the server system sends to the second electronic device the network information of the first electronic device and/or sending to the first electronic device the network information of the second electronic device.

In accordance with some embodiments, a non-transitory computer readable storage device includes one or more programs for execution by a server system. The one or more programs including instructions for receiving from a first electronic device a first device identifier of the first electronic device and network information of the first electronic device; and, subsequent to receiving from the first electronic device the first device identifier of the first electronic device and the network information of the first electronic device, receiving from a second electronic device, that is distinct from the first electronic device, a second device identifier of the second electronic device and network information of the second electronic device. The second device identifier is distinct from the first device identifier. The one or more programs also include instructions for, in response to receiving from the second electronic device the second device identifier of the second electronic device and the network information of the second electronic device, determining whether the first device identifier is associated with the second device identifier; and, in accordance with a determination that the first device identifier is associated with the second device identifier, sending to the second electronic device the network information of the first electronic device and/or sending to the first electronic device the network information of the second electronic device.

Thus, server systems are provided with methods for distributing network information for faster and more efficient establishment of peer-to-peer connections, thereby increasing effectiveness, efficiency, and user satisfaction with such devices. Such server systems and methods may complement or replace conventional server systems and methods for supporting peer-to-peer connections.

In accordance with some embodiments, a method is performed at an electronic device that includes one or more processors and memory. The method includes sending to a server system a device identifier of the electronic device and network information of the electronic device; and, subsequent to sending to the server system the device identifier of the electronic device and the network information of the electronic device, receiving from the server system network information of a second electronic device. The method also includes, subsequent to receiving from the server system network information of the second electronic device, sending to the second electronic device a request to establish a peer-to-peer connection with the second electronic device, without sending a request to the server system to establish the peer-to-peer connection with the second electronic device.

In accordance with some embodiments, an electronic device includes one or more processors; and memory storing one or more programs for execution by the one or more processors. The electronic device sends to a server system a device identifier of the electronic device and network information of the electronic device; and, subsequent to sending to the server system the device identifier of the electronic device and the network information of the electronic device, receives from the server system network information of a second electronic device. The electronic device, subsequent to receiving from the server system network information of the second electronic device, sends to the second electronic device a request to establish a peer-to-peer connection with the second electronic device, without sending a request to the server system to establish the peer-to-peer connection with the second electronic device.

In accordance with some embodiments, a non-transitory computer readable storage device stores one or more programs for execution by an electronic device. The one or more programs including instructions for sending to a server system a device identifier of the electronic device and network information of the electronic device; and, subsequent to sending to the server system the device identifier of the electronic device and the network information of the electronic device, receiving from the server system network information of a second electronic device. The one or more programs also include instructions for, subsequent to receiving from the server system network information of the second electronic device, sending to the second electronic device a request to establish a peer-to-peer connection with the second electronic device, without sending a request to the server system to establish the peer-to-peer connection with the second electronic device.

Thus, electronic devices are provided with faster, more efficient methods for establishing peer-to-peer connections, thereby increasing effectiveness, efficiency, and user satisfaction with such devices. Such devices and methods may complement or replace conventional devices and methods for establishing peer-to-peer connections.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIGS. 1A-1F are exemplary network diagrams illustrating operations of a distributed computer system in accordance with some embodiments.

FIG. 2 is an exemplary network diagram illustrating operations of a plurality of electronic devices in accordance with some embodiments.

FIGS. 3A-3B are exemplary user interfaces of electronic devices in accordance with some embodiments.

FIG. 4 is a block diagram illustrating an exemplary server system in accordance with some embodiments.

FIG. 5 is a block diagram illustrating an exemplary electronic device in accordance with some embodiments.

FIG. 6 is a flow diagram illustrating operations of a distributed computer system in accordance with some embodiments.

FIGS. 7A-7E are flow diagrams illustrating a method of distributing network information in accordance with some embodiments.

FIGS. 8A-8C are flow diagrams illustrating a method of establishing a peer-to-peer connection in accordance with some embodiments.

### DESCRIPTION OF EMBODIMENTS

As described above, existing methods for VoIP and video conference calls are complicated, cumbersome, and inefficient. In addition, the use of a username and a password can be vulnerable to security breaches. For example, a malicious attacker may obtain a username and a password of a victim by various means (e.g., social engineering, phishing, snooping, brute force attacks, etc.), pretend to be the victim, and steal confidential information through VoIP calls.

As described below, device identifiers of electronic devices (e.g., hardware-specific identifiers) are used instead of, or in addition to, usernames and passwords. Because usernames and passwords need not be provided, this eliminates the need for typing in usernames and passwords, thereby allowing users to establish peer-to-peer connections and make VoIP or video conference calls faster and more efficiently.

In addition, because personal information, such as usernames, email addresses, cell phone numbers, are not used, privacy of the users can be better protected from a malicious attacker.

Furthermore, because hardware-specific identifiers (e.g., hard-coded identifiers) are used, security and reliability in peer-to-peer communications are improved.

Individuals who are not accustomed to new communications technology/devices would especially benefit from such devices and methods, because such individuals do not need to go through multiple steps of setting up devices for peer-to-peer communications (e.g., VoIP and/or video conference calls). In addition, a group of users (e.g., family members) who want direct and immediate connection to each other would benefit from the ability to connect to each other immediately without separate manual logging-in steps. Furthermore, businesses and other organizations that must keep in frequent touch with individuals at different locations can benefit from hosting a conference call without exposing participants' personal information (e.g., email addresses, usernames, or phone numbers of the participants).

With devices and methods described herein, a number of user actions is significantly reduced (e.g., a user does not need to type in a username and a password) to place an electronic device in a standby mode. For example, a user may need to plug a power cable in and enable the Internet connection to place the electronic device in a standby mode (in which the electronic device has network information of a peer electronic device). In some cases, such as with a device in a mobile network or a device with WiFi signals, the device automatically finds the Internet connection, which eliminates the need for the user to manually enable the Internet connection.

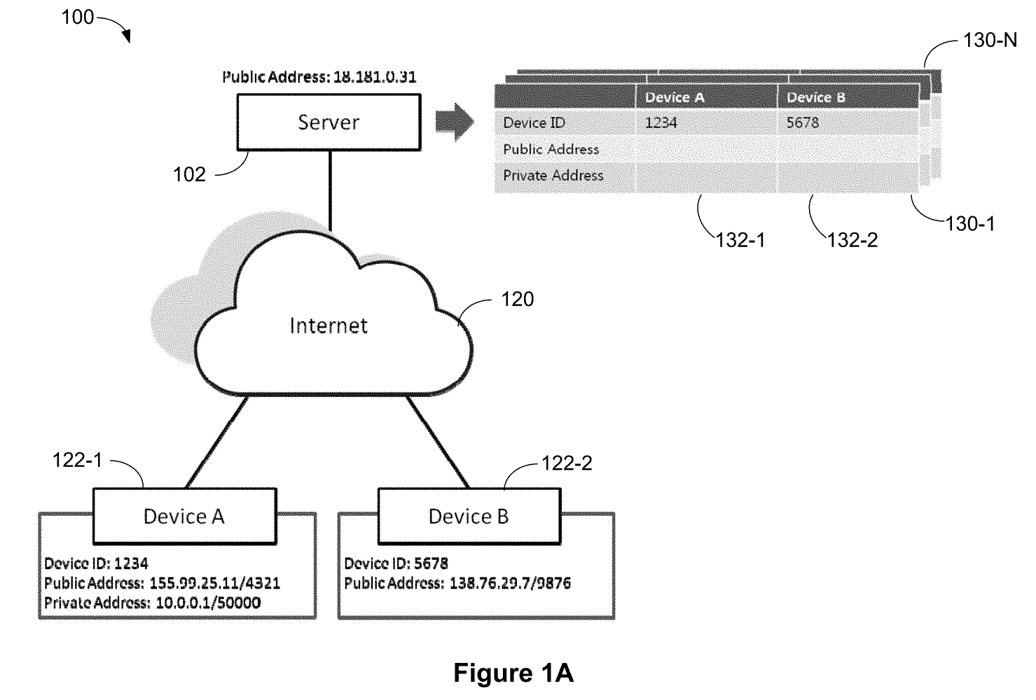

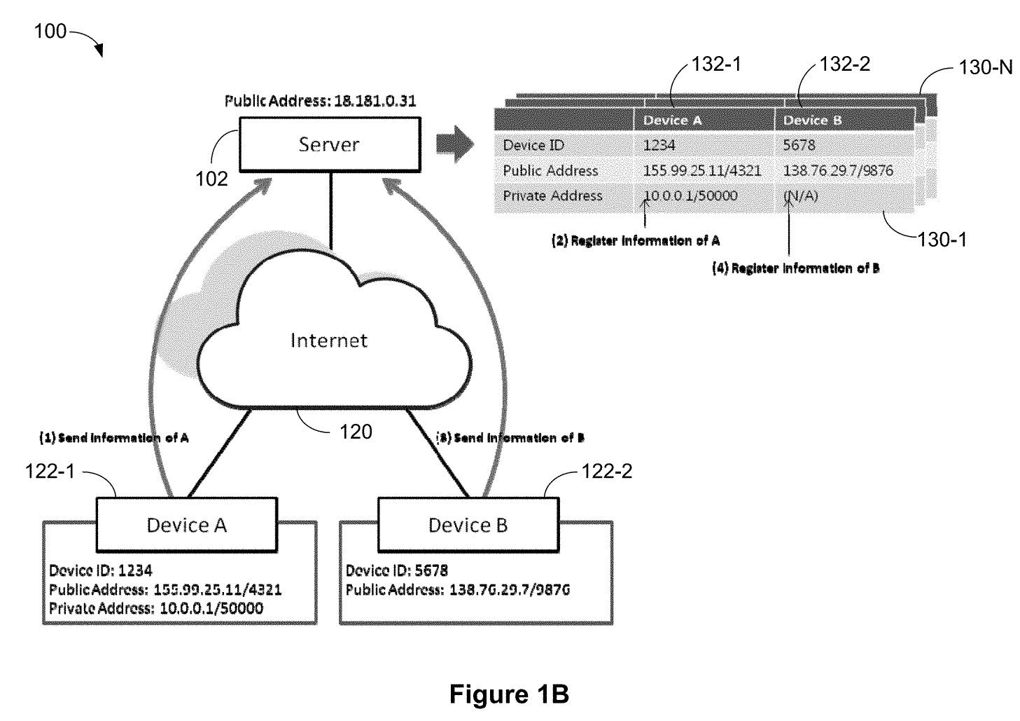

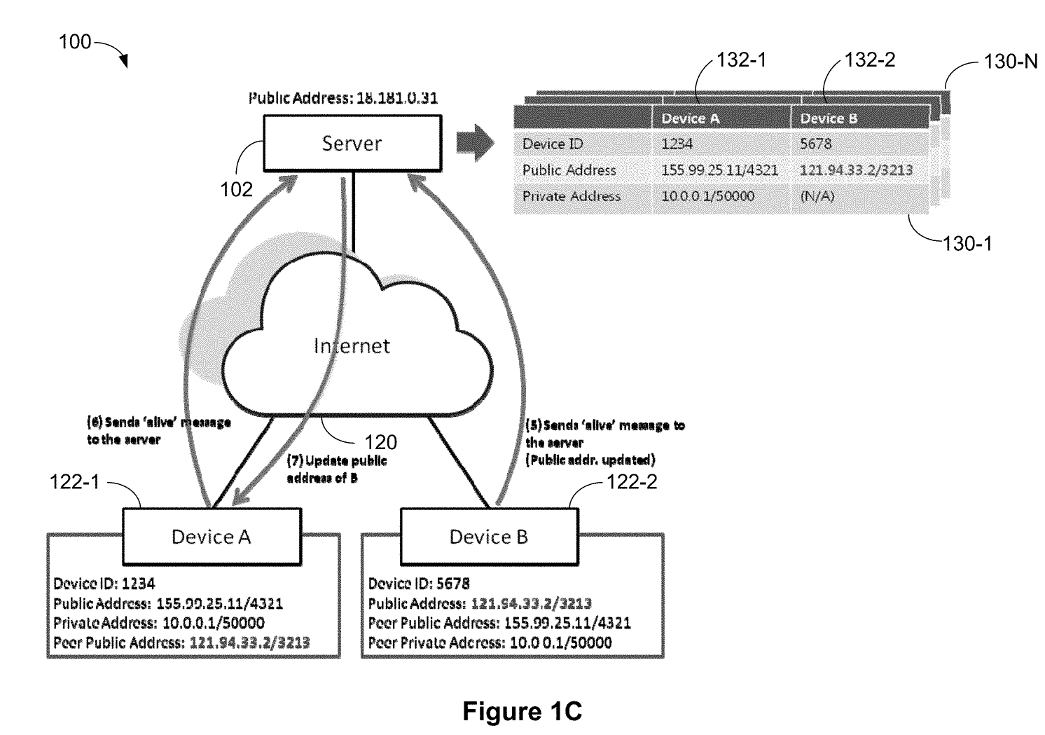

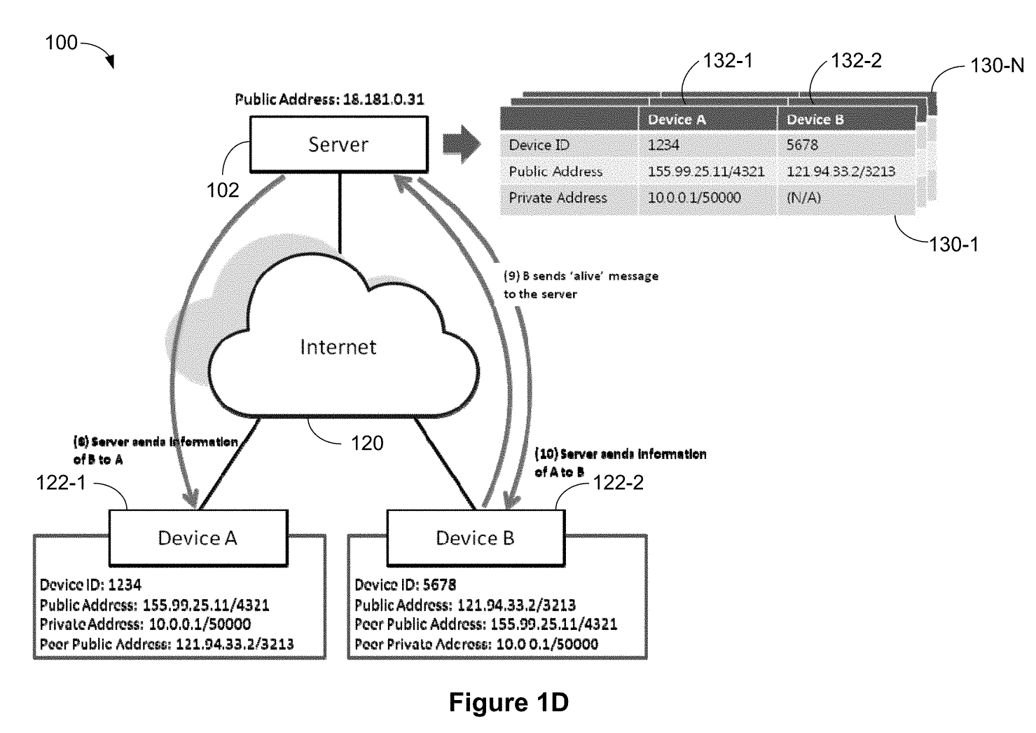

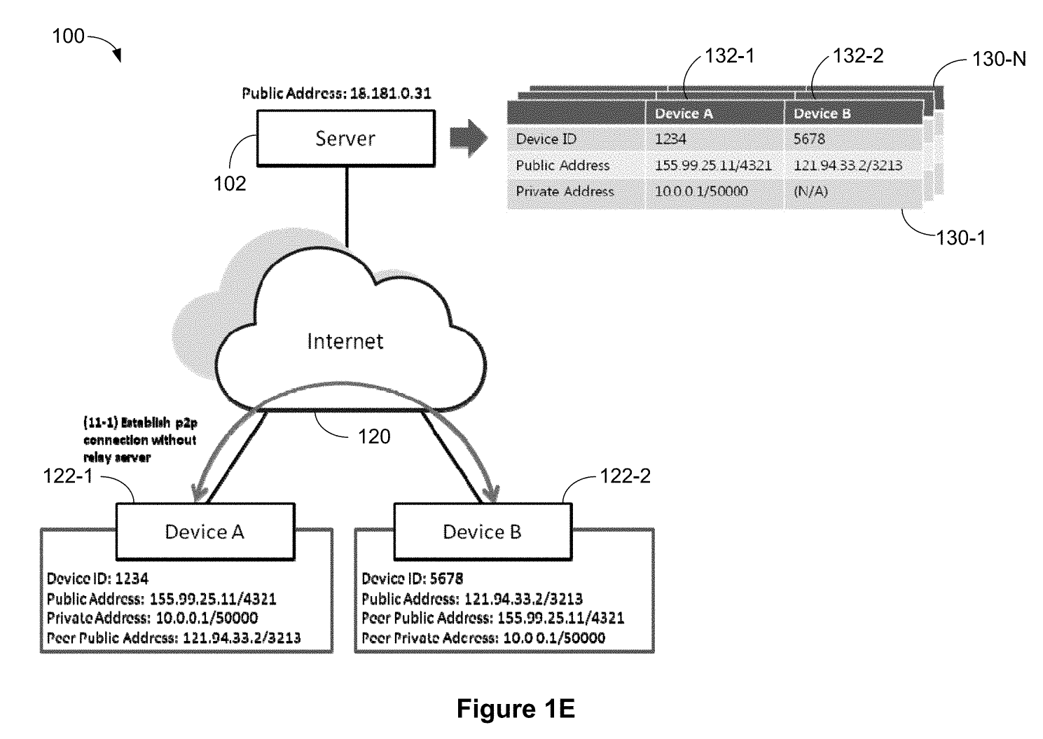

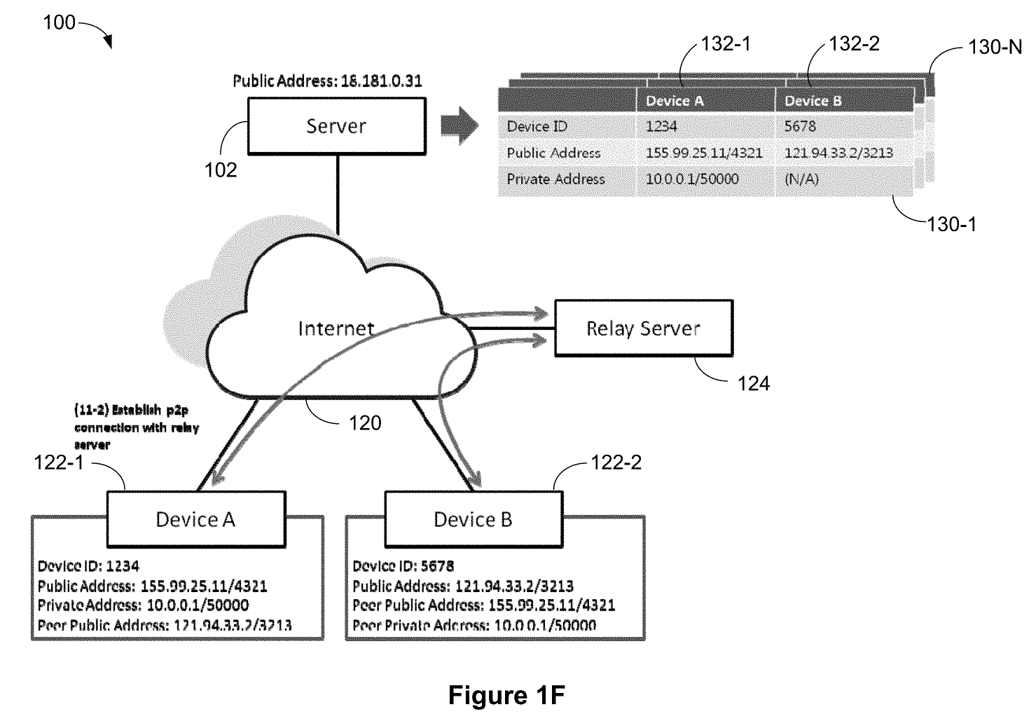

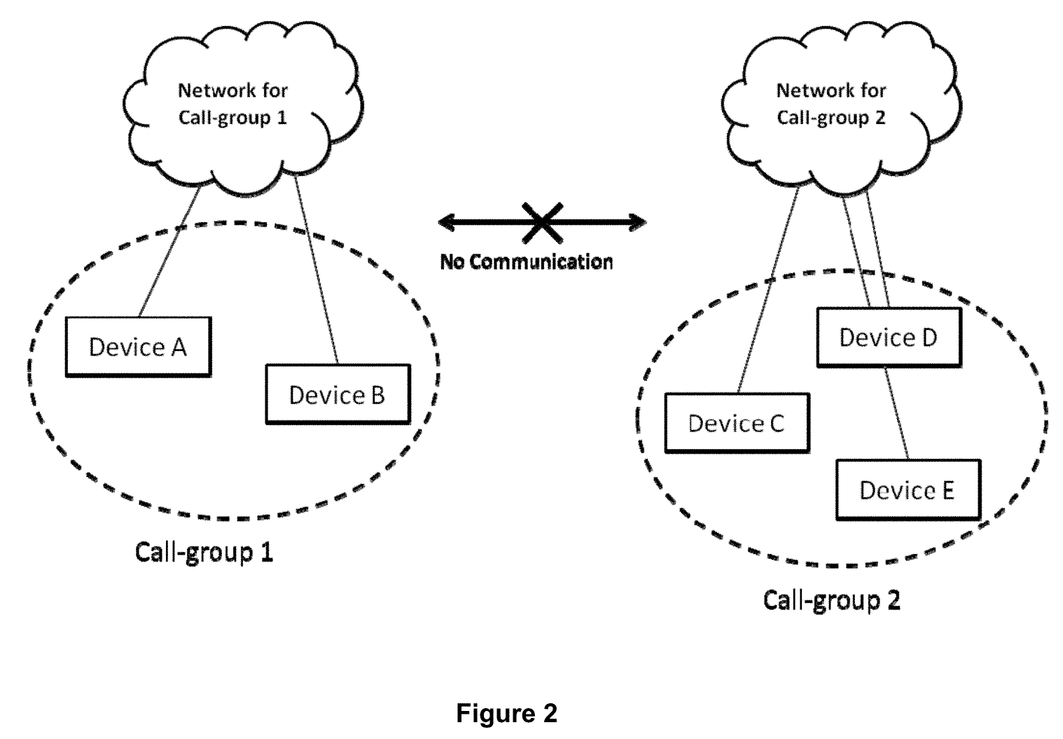

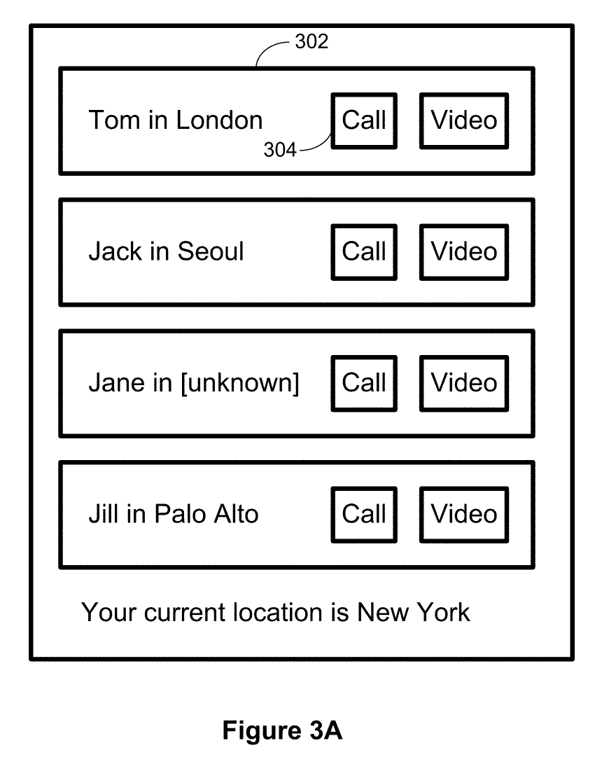

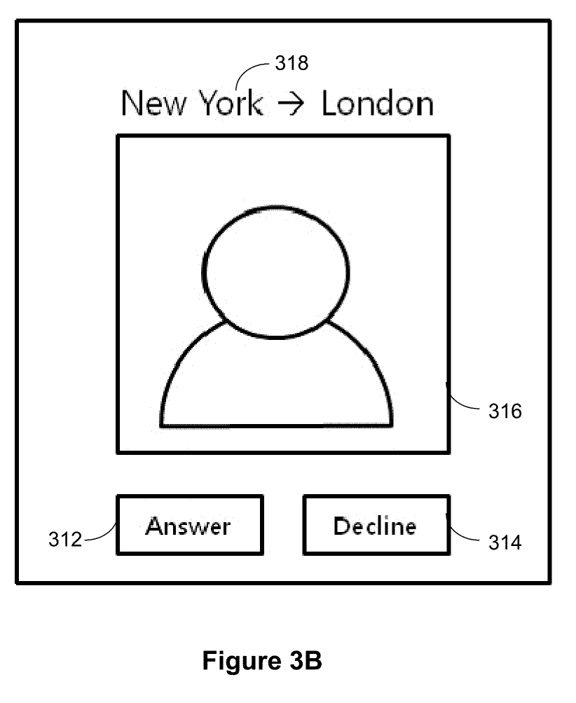

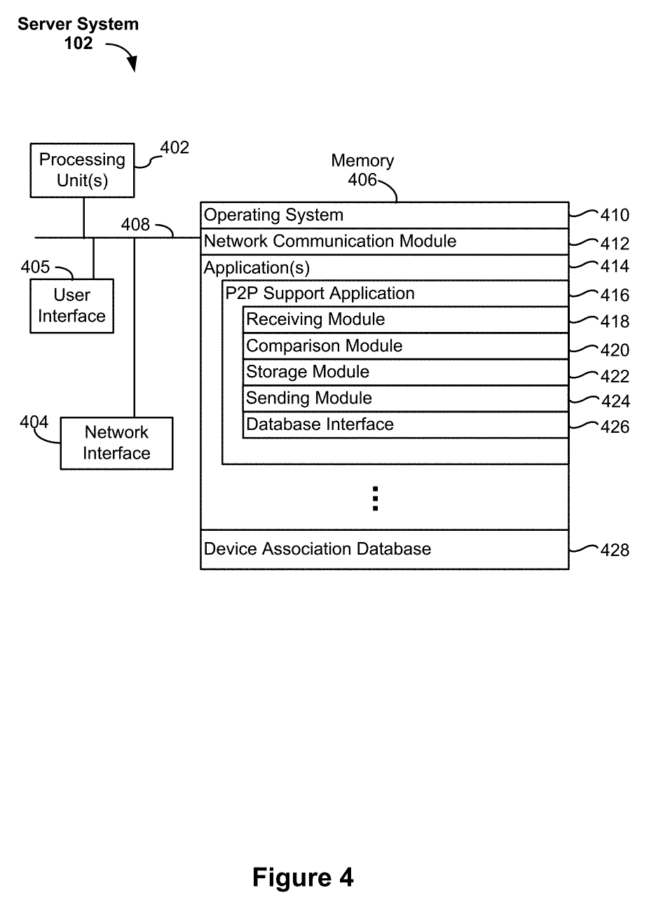

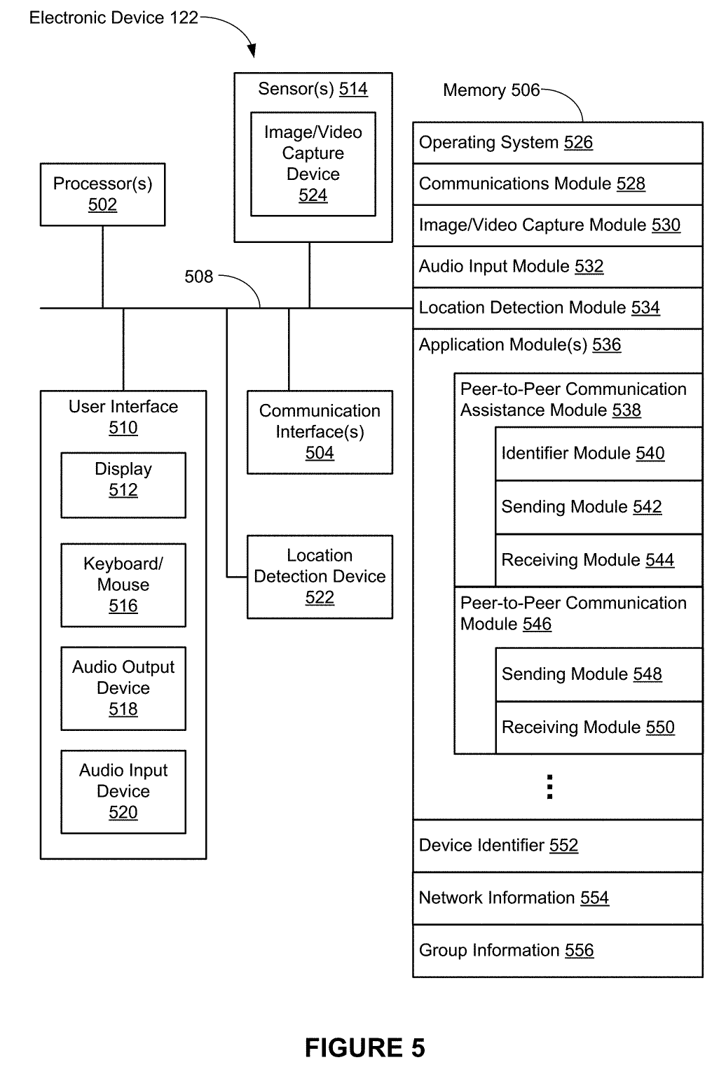

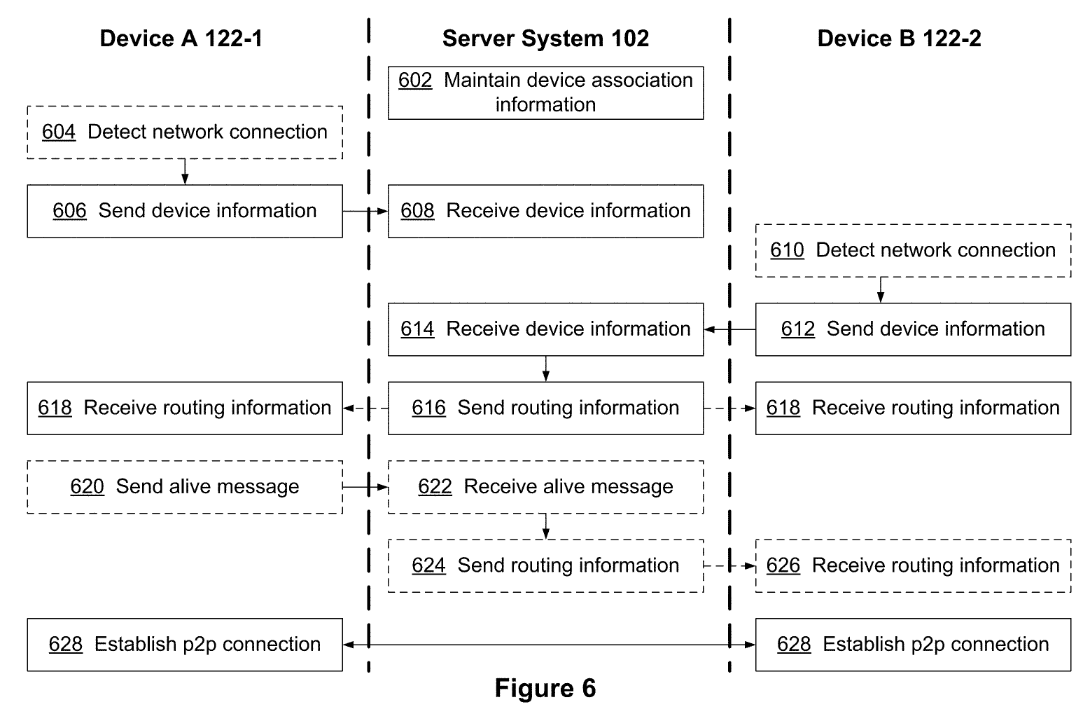

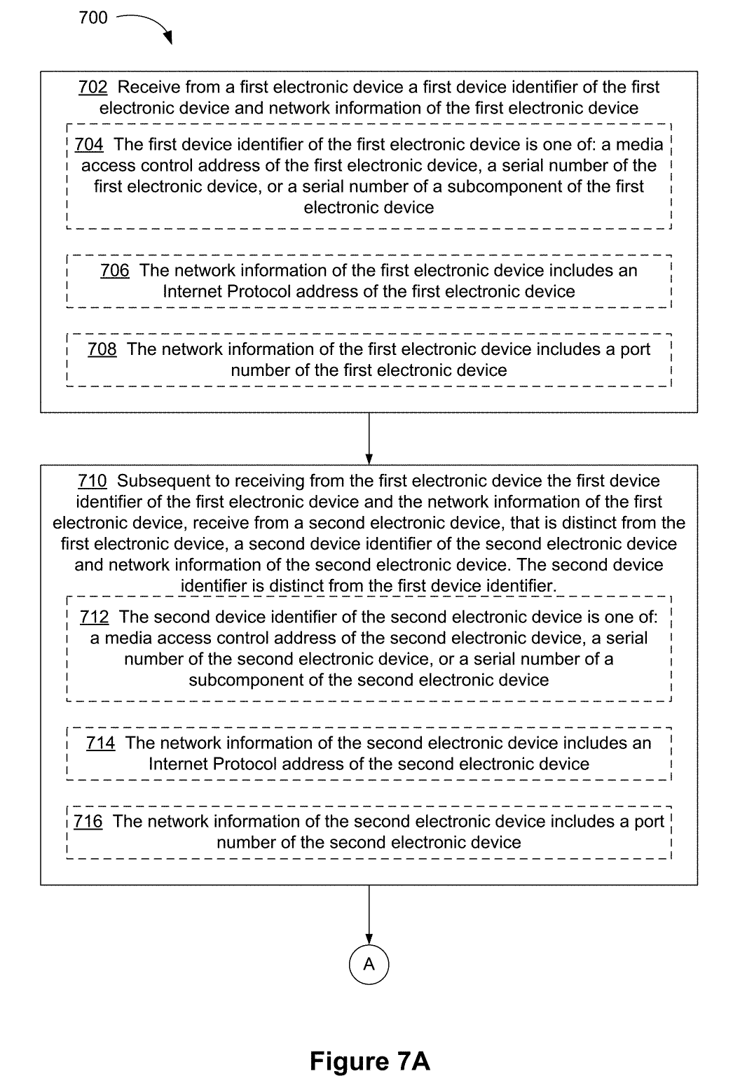

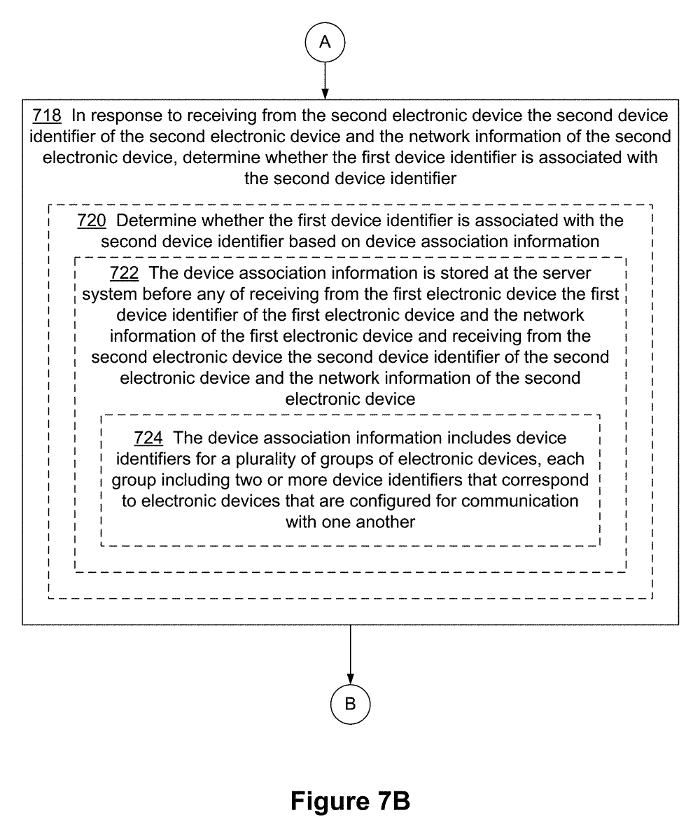

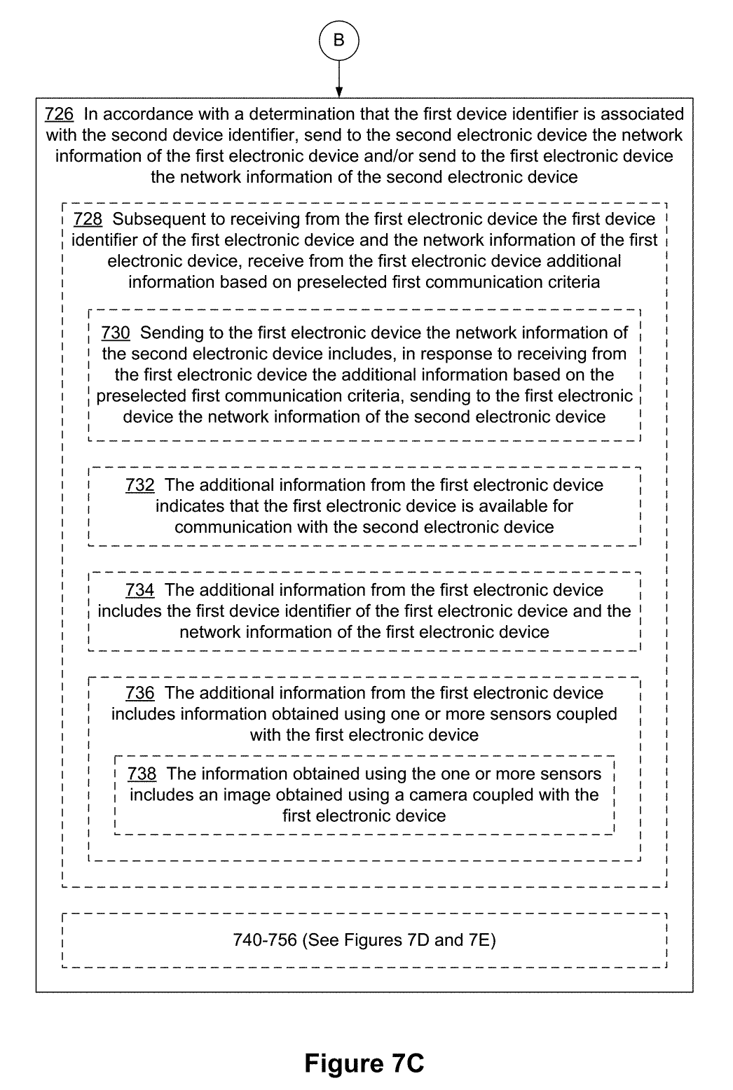

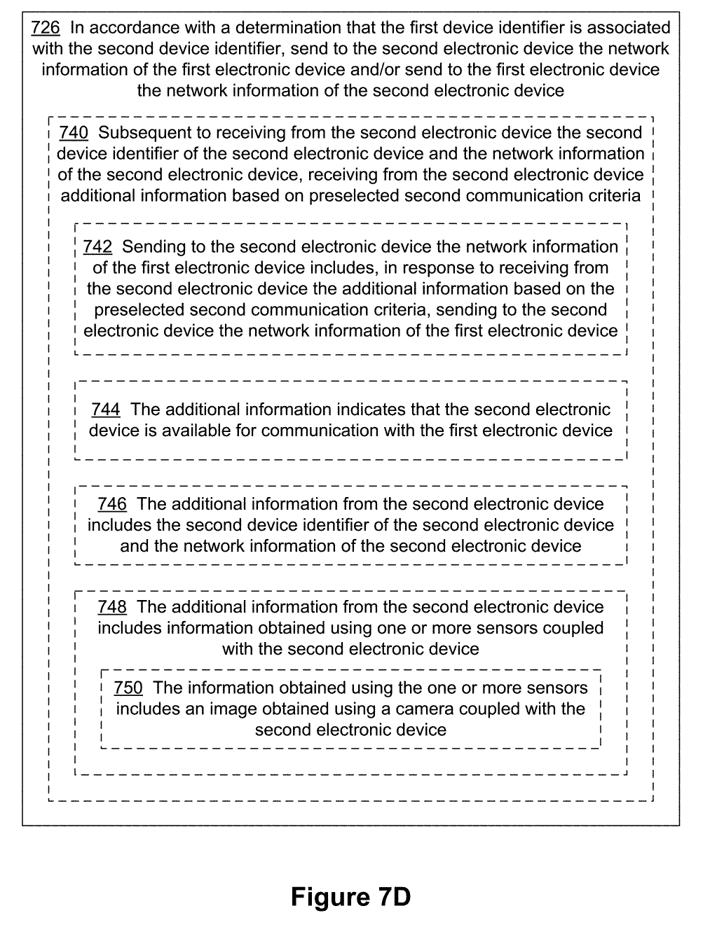

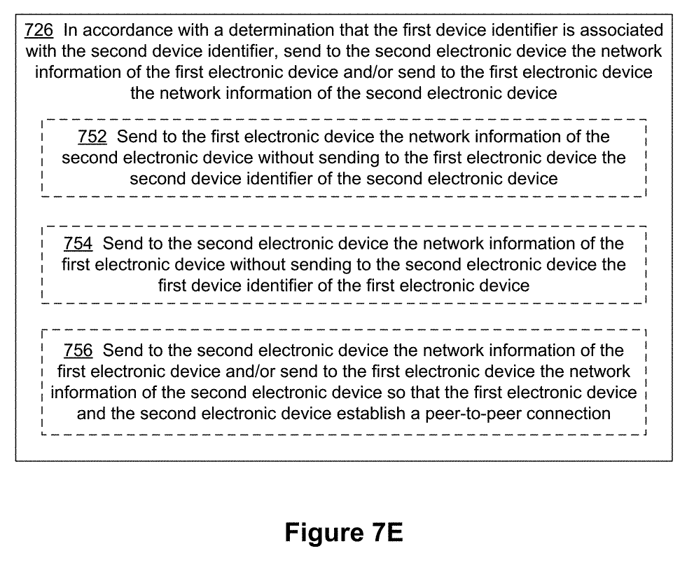

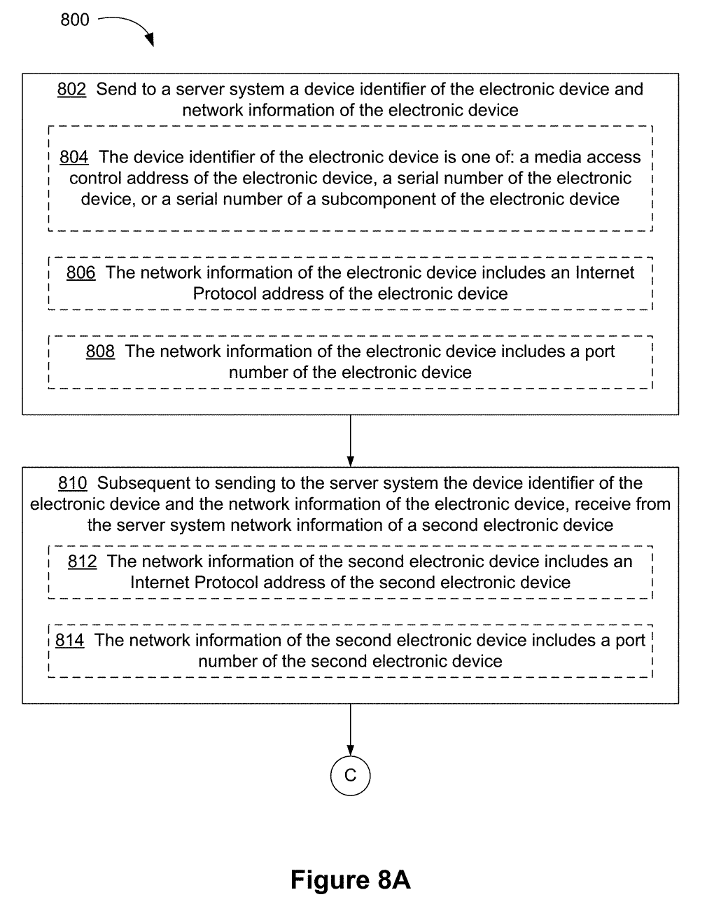

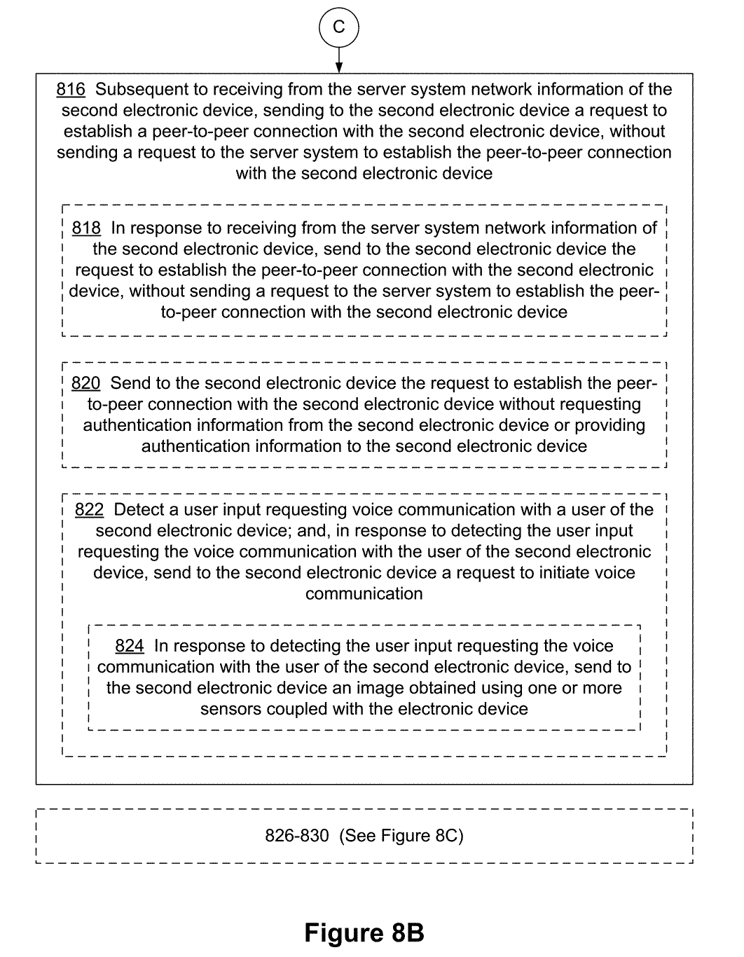

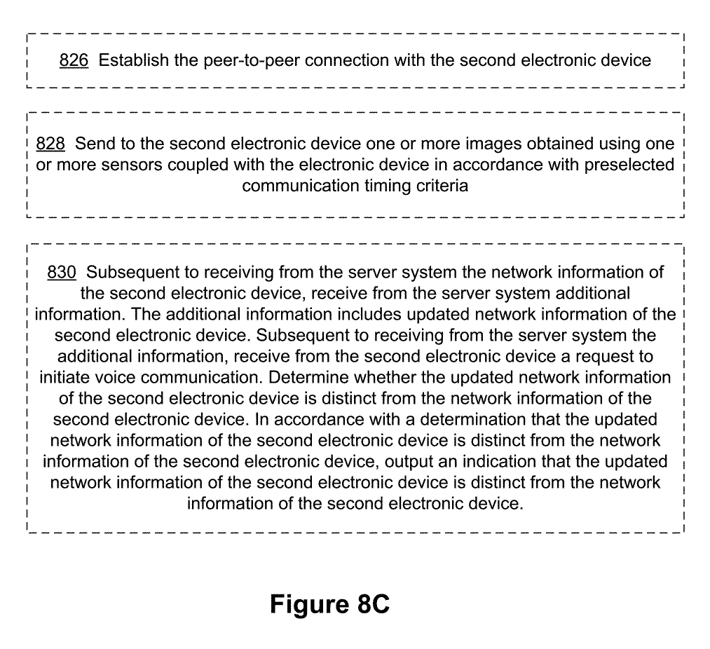

Below, FIGS. 1A-1F illustrate operations of a distributed computer system. FIG. 2 illustrates operations of a plurality of electronic devices. FIGS. 3A-3B are exemplary user interfaces of electronic devices. FIG. 4 is a block diagram illustrating an exemplary server system. FIG. 5 is a block diagram illustrating an exemplary electronic device. FIG. 6 is a flow diagram illustrating operations of a distributed computer system. FIGS. 7A-7E are flow diagrams illustrating a method of distributing network information. FIGS. 8A-8C are flow diagrams illustrating a method of establishing a peer-to-peer connection. The diagrams in FIGS. 1A-1F, 2, 3A-3B, and 4-5 are used to illustrate the operations in FIGS. 6, 7A-7E, and 8A-8C.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are only used to distinguish one element from another. For example, a first electronic device could be termed a second electronic device, and, similarly, a second electronic device could be termed a first electronic device, without departing from the scope of the various described embodiments. The first electronic device and the second electronic device are both electronic devices, but they are not the same electronic device.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

FIGS. 1A-1F are exemplary network diagrams illustrating operations of a distributed computer system 100 in accordance with some embodiments.

In FIG. 1A, the distributed computer system 100 includes a server system 102, a plurality of electronic devices 122 (e.g., an electronic device 122-1 and an electronic device 122-2), and communication networks 120 (e.g., Internet, etc.).

An electronic device 122 can be any computing device (e.g., a laptop computer and a desktop computer, etc.). In some embodiments, an electronic device 122 includes a portable electronic device (e.g., a mobile phone, a handheld computer, a tablet, etc.). In some embodiments, the electronic device 122 includes a graphical user interface (GUI) for graphically displaying information.

In FIG. 1A, the electronic device 122-1 (also called herein Device A) has a device identifier “1234” and one or more network addresses, such as a public network address 155.99.25.11/4321 (e.g., an Internet protocol (IP) address 155.99.25.11 and a port number 4321), and a private network address of 10.0.0.1/50000. The device identifier 1234 (e.g., a string of characters) uniquely identifies the electronic device 122-1. The electronic device 122-2 (also called herein Device B) has a device identifier “5678” and one or more network addresses, such as a public network address 138.76.29.7/9876 (e.g., an IP address 138.76.29.7 and a port number 9876). In some embodiments, a device identifier of an electronic device is a media access control (MAC) address of the electronic device. In some embodiments, a device identifier of an electronic device includes at least a subset of a media access control (MAC) address of the electronic device. The electronic devices 122 (e.g., the electronic device 122-1 and the electronic device 122-2) are connected to the server system 102 via communication networks 120.

The communication networks 120 can be any combination of one or more wired or wireless networks, such as Internet, local area networks, large area networks, wide area networks, cellular networks, etc. In some embodiments, the communication networks 120 utilize various communication technologies, such as Ethernet, WiFi, Long Term Evolution (LTE), the third generation of mobile telecommunications technology (commonly known as 3G), the fourth generation of mobile telecommunications technology (commonly known as 4G), etc.

The server system 102 is a computer server configured to interact with the electronic devices 122. In some embodiments, the server system 102 represents multiple server computers. In FIG. 1A, the server system 102 has a public network address (e.g., 18.181.0.31). This allows electronic devices to create connections to the server using the public network address.

In some embodiments, the server system 102 stores device association information 130. The device association information 130 identifies one or more groups (also called herein “peer-to-peer communication group” or “call-groups”) of electronic devices that are selected for peer-to-peer communication. In FIG. 1A, the device association information 130 includes information for a plurality of groups (e.g., device association information 130-1 for a first group of electronic devices and device association information 130-N for an N-th group of electronic devices). The device association information 130-1 includes information 132-1 identifying Device A 122-1 and information 132-2 identifying Device B 122-2. In some embodiments, the device association 130-1 includes information identifying additional devices. The information 132-1 includes the device identifier 1234 of Device A 122-1 and the device identifier 5678 of Device B 122-2. The device association information 130-1 indicates that an electronic device that has the device identifier 1234 (e.g., Device A 122-1) and an electronic device that has the device identifier 5678 are selected for peer-to-peer communication with each other. In some embodiments, device association information 130-1 identifies three or more electronic devices for peer-to-peer communication with one another.

In FIG. 1B, Device A 122-1 sends (1) information to the server system 102. The information from Device A 122-1 includes the device identifier “1234” and one or more network addresses (e.g., the public network address and/or the private network address) of Device A 122-1. The server system 102 receives the information from Device A 122-1. By comparing the device identifier “1234” of Device A 122-1 and device identifiers in the device association information 130, the server system 102 determines that the device identifier “1234” matches a device identifier in the device association information 130-1, and stores (2) the information received from Device A 122-1 in the device association information 130-1 (e.g., the one or more network addresses of Device A 122-1 are stored in the device association information 130-1). Device B 122-2 also sends (3) information to the server system 102. The information from Device B 122-2 includes the device identifier “5678” and one or more network addresses of Device B 122-2. The server system 102 receives the information from Device B 122-2. By comparing the device identifier “5678” of Device B and device identifiers in the device association information 130, the server system 102 determines that the device identifier “5678” matches a device identifier in the device association information 130-1, and stores (4) the information received from Device B 122-2 in the device association information 130-1 (e.g., the one or more network addresses of Device B 122-2 are stored in the device association information 130-1).

In some embodiments, a single electronic device belongs to multiple groups. For example, the device identifier “1234” of Device A 132-1 may be included in device association information 130 for multiple groups (e.g., the device identifier is included in both device association information 130-1 and device association information 130-N).

In FIG. 1C, the server system 102 sends the one or more network addresses of Device B 122-2 to Device A 122-1.

In some embodiments, Device B 122-2 periodically sends (5) an “alive” message to the server system 102. In some embodiments, the “alive” message includes the device identifier of Device B 122-2 and one or more network addresses of Device B 122-2. For example, the public network address of Device B 122-2 has changed to 121.94.33.2/3213, and the “alive” message sent by Device 122-2 includes the changed public network address of Device B 122-2. In some embodiments, the “alive” message also includes data obtained using one or more sensors coupled with Device B 122-2 (e.g., an image obtained using a camera of Device B 122-2).

In some embodiments, Device A 122-1 periodically sends (6) an “alive” message to the server system 102. In some embodiments, the “alive” message includes the device identifier of Device A 122-1 and one or more network addresses of Device A 122-1. As shown in FIG. 1C, an “alive” message need not include a changed network address (e.g., the “alive” message includes a network address that is the same as in a previous “alive” message). In some embodiments, the “alive” message also includes data obtained using one or more sensors coupled with Device A 122-1 (e.g., an image obtained using a camera of Device A 122-1).

FIG. 1C also illustrates that the server system 102 sends (7) the one or more network addresses (e.g., the changed public network address) of Device B 122-2 to Device A 122-1 in response to receiving the “alive” message from Device A 122-1. Alternatively, or additionally, the server system 102 sends the one or more network addresses of Device B 122-2 to Device A 122-1 independent of receiving the “alive” message from Device A 122-1.

For example, in FIG. 1D, the server system 102 sends (8) the one or more network addresses of Device B to Device A 122-1 without receiving an “alive” message from Device A 122-1.

FIG. 1D also illustrates that Device B 122-2 sends (9) an “alive” message to the server system 102. The server system 102 receives the “alive” message from Device B 122-2, and in response to receiving the “alive” message from Device B 122-2, sends (10) the one or more network addresses of Device A 122-1 to Device B 122-2.

FIG. 1E illustrates that a peer-to-peer (p2p) connection is established directly between Device A 122-1 and Device B 122-2.

Alternatively, as shown in FIG. 1F, a peer-to-peer connection is established between Device A 122-1 and Device B 122-2 through a relay server 124.

In some embodiments, the peer-to-peer connections in FIGS. 1E and 1F are based on a Transmission Control Protocol (TCP) connection or a User Datagram Protocol (UDP) session. A peer-to-peer connection can be used for a VoIP or video conference call.

Although FIGS. 1A-1F illustrate a distributed computer system with two electronic devices, a person having ordinary skill in the art would understand that analogous operations can be performed with three or more electronic devices. For brevity, such details are omitted herein.

FIG. 2 is an exemplary network diagram illustrating operations of a plurality of electronic devices in accordance with some embodiments.

In FIG. 2, Device A and Device B belong to a first group (called herein “call-group 1”), and Device C, Device D, and Device E belong to a second group (called herein “call-group 2”). A device in the call-group 1 (e.g., Device A) can directly communicate with the other device in the call-group 1 (e.g., Device B), and a device in the call-group 2 (e.g., Device C) can directly communicate with the other devices in the call-group 2 (e.g., Device D and/or Device E). However, in some embodiments, a device in the call-group 1 is not capable of directly communicating with a device in the call-group 2. As used herein, a direct communication refers to a communication that does not require sending communication packets to the server system 102. However, a direction communication between two electronic devices can involve additional network components between the two electronic devices. For example, a direct communication between two electronic devices involves multiple network communication components and devices (e.g., hubs, switches, etc.) located between the two electronic devices.

Typically, an electronic device in a particular call-group does not receive network information of another electronic device that does not belong to the particular call-group. The electronic device receives network information of electronic device(s) in the same particular call-group. This inherent exclusiveness reduces the need for authentication processes.

In FIG. 2, although a network for the call-group 1 and a network for the call group 2 are drawn separately, the network for the call-group 1 and the network for the call group 2 may have an overlap. For example, in some embodiments, the network for the call-group 1 and the network for the call-group 2 include a same network component (e.g., a switch).

FIGS. 3A-3B are exemplary user interfaces of electronic devices (e.g., Device A 122-1 and Device B 122-2, FIG. 1E) in accordance with some embodiments.

FIG. 3A illustrates a user interface on a first electronic device (e.g., Device A 122-1, FIG. 1E). The user interface includes a list of contacts (e.g., users associated with a user of Device A 122-1), such as Tom, Jack, Jane, and Jill. In some embodiments, the list of contacts also includes locations of one or more contacts. A respective entry 302 of the list includes one or more user interface elements (e.g., icons) for requesting communication, such as a call icon 304 and a video conference call icon. The call icon 304, when selected, initiates voice communication with a corresponding user (e.g., a VoIP call with Tom). For example, the first electronic device sends a request to initiate voice communication to a second electronic device (e.g., Device B 122-2) associated with the corresponding user (e.g., Tom).

The user interface in FIG. 3B is displayed by the second electronic device in response to receiving a request to initiate voice communication from the first electronic device.

In FIG. 3B, the user interface includes an “answer” user interface element 312 for accepting the request from the electronic device and a “decline” user interface element 314 for declining the request from the electronic device.

The user interface also includes an image 316 that has been sent from the electronic device. In some embodiments, the image 316 is an image obtained using a sensor (e.g., a camera) coupled with the electronic device. The image 316 assists a user of the second electronic device to determine whether the request to initiate voice communication has been made by a person that the user recognizes. In some embodiments, the image 316 corresponds to an image obtained by the electronic device in response to a selection of the call icon 304.

The user interface further includes a location indicator 318 that identifies a location of the electronic device. In some embodiments, the location of the electronic device is determined based on one or more network addresses of the electronic device (e.g., using an IP geolocation tool). The location indicator 318 assists the user of the second electronic device to determine whether the request has been made by a person that the user recognizes.

In some embodiments, the user interface of the second electronic device includes additional user interface elements not described herein and/or a subset of the user interface elements described above.

FIG. 4 is a block diagram illustrating an exemplary server system 102 in accordance with some embodiments.

The server system 102 includes one or more processing units 402 (e.g., one or more central processing units (CPUs), one or more graphical processing units (GPUs), and one or more accelerated processing units (APUs)), one or more network or other communication interfaces 404, memory 406, and one or more communication buses 408 for interconnecting these components. A processing unit is also called herein a processor. In some embodiments, the server system 102 includes a user interface 405 comprising a display device and one or more input devices, such as a keyboard, mouse, touchpad, touch screen and/or other input devices.

Memory 406 typically includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 406 optionally includes one or more storage devices remotely located from the Processing unit(s) 402. Memory 406, or alternatively the non-volatile memory device(s) within memory 406, comprises a non-transitory computer readable storage medium. In some embodiments, memory 406 or alternatively the non-transitory computer readable storage medium stores the following programs, modules and data structures, or a subset thereof:
an operating system 410 that includes procedures for handling various basic system services and for performing hardware dependent tasks;
a network communication module (or instructions) 412, configured for connecting the server system 102 to other electronic devices (e.g., electronic device 122-1, electronic device 122-2, etc.) via one or more network interfaces 404 (wired or wireless) and one or more communication networks 120 (FIG. 1A), such as the Internet, other wide area networks, local area networks, metropolitan area networks, and so on;
application(s) 414; and
device association database 428 storing device association information (e.g., device association information 130, FIGS. 1A-1F).

The application(s) 414 includes one or more applications 414 (e.g., sets of multiple instructions) configured for execution by the server system 102. In some embodiments, the application(s) 414 includes a peer-to-peer communication support application 416. In some embodiments, the peer-to-peer communication support application 416 includes the following components, or a subset or a superset thereof:
a receiving module 418 configured for receiving information (e.g., device identifiers and network information, such as network addresses) from one or more electronic devices 122 and/or processing the received information;
a comparison module 420 configured for comparing device identifiers (e.g., comparing a received device identifier and device identifiers stored in the device association database);
a storage module 422 configured for storing data into the device association database 428 (e.g., updating network information of a device that has a matching device identifier);
a sending module 424 configured for preparing information (e.g., network information) and/or sending the information to one or more electronic devices 122; and
a database interface 426 configured for assisting one or more modules (e.g., comparison module 420 and/or storage module 422) access to the device association database 428 (e.g., retrieving data from, and/or storing data in, the device association database 428).

In some embodiments, the device association database 428 is generated and/or updated using a dedicated webpage or a smart phone application. For example, a user who knows at least one device identifier may modify a call-group (e.g., add or delete user identifiers in the call-group). In some embodiments, a webpage authentication based on a device identifier can be more secure than an authentication process based on a username and a password. In some embodiments, the server system 102 presents security questions regarding the call-group (e.g., a size of the call-group or a geographic location of a respective electronic device in the call-group) prior to allowing a modification to the call-group.

Each of the above identified elements may be stored in one or more of the previously mentioned memory devices, and corresponds to a set of instructions for performing a function described above. The above identified modules or programs (e.g., sets of instructions) need not be implemented as separate software programs, procedures or modules, and thus various subsets of these modules may be combined or otherwise re-arranged in various embodiments. In some embodiments, memory 406 stores a subset of the modules and data structures identified above. Furthermore, in some embodiments, memory 406 stores additional modules and data structures not described above.

Although FIG. 4 shows the server system 102 in accordance with some embodiments, as recognized by those of ordinary skill in the art, items shown separately could be combined and some items could be separated. For example, the storage module 422 and the database interface 426 may be combined in a single module.

Some items shown separately in FIG. 4 could be implemented on single servers and single items could be implemented by one or more servers. For example, in some embodiments, the comparison module 420 and the storage module 422 are implemented in separate servers. The actual number of servers used to implement the server system 102 and how features are allocated among them will vary from one implementation to another, and optionally depends in part on the amount of data traffic that the server must handle during peak usage periods as well as during average usage periods.

FIG. 5 is a block diagram illustrating an exemplary electronic device 122 in accordance with some embodiments. In some embodiments, the electronic device 166 is a mobile device (e.g., a mobile phone). In some embodiments, the electronic device 166 is a stationary device (e.g., a desktop computer or a stationary phone).

The electronic device 122 typically includes one or more processing units (processors or cores) 502, one or more network or other communications interfaces 504, memory 506, and one or more communication buses 508 for interconnecting these components. The communication buses 508 optionally include circuitry (sometimes called a chipset) that interconnects and controls communications between system components.

In some embodiments, the electronic device 122 includes a user interface 510. In some embodiments, the user interface 510 includes a touch-sensitive surface. The user interface 510 typically includes a display device 512. In some embodiments, the device 122 includes inputs such as a keyboard, mouse, and/or other input buttons 516. In some embodiments, the display device 512 includes the touch-sensitive surface, in which case the display device 512 is a touch-sensitive display. In electronic devices that have a touch-sensitive display, a physical keyboard is optional (e.g., a soft keyboard may be displayed when keyboard entry is needed). In some embodiments, the touch-sensitive surface is located independent of the display 512 (e.g., the touch-sensitive surface is separate from the display 512). In some embodiments, the touch-sensitive surface is configured to detect a touch on a sensing area of the touch-sensitive surface.

Optionally, the user interface 510 also includes an audio output device 518, such as speakers or an audio output connection connected to speakers, earphones, or headphones. Furthermore, some electronic devices 122 use a microphone and voice recognition to supplement or replace the keyboard. Optionally, the electronic device 122 includes an audio input device 520 (e.g., a microphone) to capture audio (e.g., speech from a user). Optionally, the client device 122 includes a location detection device 522, such as a GPS (global positioning satellite) or other geo-location receiver, for determining the location of the client device 122.

The electronic device 122 also optionally includes one or more sensors 514. In some embodiments, the one or more sensors 514 include an image/video capture device 524, such as a camera or webcam. In some embodiments, the image/video capture device 524 includes an infrared camera. In some embodiments, the infrared camera includes a gate-controlled charge modulated device as described in International Application Serial No. PCT/US14/43421, filed on Jun. 20, 2014, which is incorporated by reference herein in its entirety. In some embodiments, the one or more sensors 514 include one or more of: a temperature sensor, a carbon-monoxide sensor, a carbon-dioxide sensor, a motion sensor, a radiation sensor, and an air quality sensor.

Memory 506 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. In some embodiments, memory 506 also includes read-only memory (ROM). Memory 506 may optionally include one or more storage devices remotely located from the processor(s) 502. Memory 506, or alternately the non-volatile memory device(s) within memory 506, includes a non-transitory computer readable storage medium. In some embodiments, memory 506 or the computer readable storage medium of memory 506 stores the following programs, modules and data structures, or a subset or superset thereof:
an operating system 526 that includes procedures for handling various basic system services and for performing hardware dependent tasks;
a network communication module 528 that is used for connecting the electronic device 122 to other electronic devices (e.g., server system 102, FIG. 1A) via the one or more communication network interfaces 504 (wired or wireless) and one or more communication networks 120, such as the Internet, cellular telephone networks, mobile data networks, other wide area networks, local area networks, metropolitan area networks, and so on;
an image/video capture module 530 (e.g., a camera module) for processing a respective image or video captured by the image/video capture device 524, where the respective image or video may be sent or streamed (e.g., by a client application module 536) to another electronic device 122;
an audio input module 532 (e.g., a microphone module) for processing audio captured by the audio input device 520, where the respective audio may be sent or streamed (e.g., by a client application module 536) to another electronic device 122;
a location detection module 534 (e.g., a GPS, Wi-Fi, or hybrid positioning module) for determining the location of the electronic device 122 (e.g., using the location detection device 522) and providing this location information to the electronic device 122 or another electronic device 122;
one or more application modules 536, including the following modules (or sets of instructions), or a subset or superset thereof:
   a peer-to-peer communication assistance module 538 for obtaining a device identifier (e.g., using the identifier module 540), sending the device identifier to a server system (e.g., using a sending module 542), and receiving network information of a peer electronic device (e.g., using a receiving module 544); and/or
   a peer-to-peer communication module 546 for establishing a peer-to-peer communication (e.g., a VoIP or video conference call, using a sending module 548 and a receiving module 550); and
one or more databases, that stores the following data, or a subset or superset thereof:
   a device identifier 552, which is typically a string of characters that uniquely identifies the electronic device 112 (e.g., a media access control (MAC) address of the communication interface 504, such as a network interface card; a hard-coded serial number of the electronic device 122; or a hard-coded serial number of a component of the electronic device 122, such as a hard drive);
   network information 554 (e.g., public and private network addresses and port numbers); and
   group information 556 (e.g., network information, such as one or more network addresses and/or port numbers, of other electronic devices in a same group (call-group)).

Each of the above identified modules and applications correspond to a set of executable instructions for performing one or more functions described above and the methods described in this application (e.g., the computer-implemented methods and other information processing methods described herein). These modules (i.e., sets of instructions) need not be implemented as separate software programs, procedures or modules, and thus various subsets of these modules are, optionally, combined or otherwise re-arranged in various embodiments. In some embodiments, memory 506 stores a subset of the modules and data structures identified above. Furthermore, memory 506 optionally stores additional modules and data structures not described above.

FIG. 6 is a flow diagram illustrating operations of a distributed computer system 100 (FIG. 1A) in accordance with some embodiments. The distributed computer system 100 includes the server system 102, Device A 122-1, and Device B 122-2.

The server system 102 maintains (602) device association information (e.g., device association information 130, FIG. 1A) prior to receiving device information from Device A 122-1 or Device B 122-2. For example, users of Device A 122-1 and Device B 122-2 have already agreed to establish peer-to-peer connection when both devices are connected to communication networks, and registered both devices in a same group in a database of the server system 102. Optionally, Device A 122-1 and Device B 122-2 are already configured in a factory as peers in a peer-to-peer communication group, and Device A 122-1 and Device B 122-2 are sold as a pair to a user. Alternatively, Device A 122-1 and Device B 122-2 are configured as peers in a peer-to-peer communication group at a time of sales.

Optionally, Device A 122-1 detects (604) network connection. For example, Device A 122-1 determines that Device A 122-1 is connected to communications networks, such as the Internet.

Device A 122-1 sends (606) device information (e.g., a device identifier) and network information (e.g., one or more network addresses and one or more port numbers) of Device A 122-1 to the server system 102. Optionally, Device A 122-1 sends device information and network information of Device A 122-1 to the server system 102 in response to detecting the network connection (e.g., without, or independent of, a user input). In some embodiments, the network information of Device A 122-1 is retrieved directly from Device A 122-1. In some embodiments, the network information of Device A 122-1 is obtained from another device coupled with Device A 122-1 (e.g., a router or a network gateway).

The server system receives (608) the device information and the network information of Device A 122-1.

Optionally, Device B 122-2 detects (610) network connection. For example, Device B 122-2 determines that Device B 122-2 is connected to communications networks, such as the Internet.

Device B 122-2 sends (612) device information (e.g., a device identifier) and network information (e.g., one or more network addresses and one or more port numbers) of Device B 122-2 to the server system 102. Optionally, Device B 122-2 sends device information and network information of Device B 122-2 to the server system 102 in response to detecting the network connection (e.g., without, or independent of, a user input).

The server system receives (614) the device information and the network information of Device B 122-2.

The server system sends (616) the network information of Device B 122-2 to Device A 122-1 and/or sends the network information of Device A 122-1 to Device B 122-2. In some embodiments, the server system sends the network information of Device B 122-2 to Device A 122-1 and sends the network information of Device A 122-1 to Device B 122-2. In some embodiments, the server system sends the network information of Device B 122-2 to Device A 122-1 without sending the network information of Device A 122-1 to Device B 122-2. In some embodiments, the server system sends the network information of Device A 122-1 to Device B 122-2 without sending the network information of Device B 122-2 to Device A 122-1.

In some embodiments, the server system distributes network information in response to receiving the device information from an electronic device already registered with the server system (e.g., a corresponding device identifier is already stored in the device association information). Receiving the device information from the electronic device indicates that the electronic device is available for a peer-to-peer communication. In some embodiments, the server system distributes network information in response to receiving an updated device information from an electronic device already registered with the server system.

Device A 122-1 and/or Device B 122-2 receive (618) respective network information.

In some embodiments, Device A 122-1 sends (620) an alive message (with original network information or updated network information) to the server system 102. The server system 102 receives (622) the alive message from Device A 122-1, and sends (624) network information (e.g., original network information or updated network information) of Device A 122-1 to Device B 122-2. Device B 122-2 receives (626) the network information of Device A 122-1 from the server system 102.

In some embodiments, Device B 122-2 sends an alive message to the server system 102. The server system receives the alive message from Device B 122-2, and sends network information of Device B 122-2 to Device A 122-1. Device A 122-1 receives the network information of Device B 122-2 from the server system 102.

Subsequently, Device A 122-1 and Device B 122-2 establish (628) peer-to-peer (p2p) connection with each other. For example, Device A 122-1 sends a request to establish a peer-to-peer connection to Device B 122-2 using the network information of Device B 122-2, and Device B 122-2 accepts the request (or sends an acceptance message to Device A 122-1), thereby establishing the peer-to-peer connection. Alternatively, Device B 122-2 sends a request to establish a peer-to-peer connection to Device A 122-1 using the network information of Device A 122-1, and Device A 122-1 accepts the request (or sends an acceptance message to Device B 122-2), thereby establishing the peer-to-peer connection. As shown in FIG. 6, Device A 122-1 and Device 122-2 do not send the request to establish a peer-to-peer connection to the server system 102.

FIGS. 7A-7E are flow diagrams illustrating a method 700 of distributing network information in accordance with some embodiments. FIGS. 7A-7E correspond to instructions stored in a computer memory or computer readable storage medium (e.g., memory 406, FIG. 4).

The method 700 is performed by a server system that includes one or more processors and memory (e.g., the server system 102, FIG. 4).

The server system receives (702) from a first electronic device a first device identifier of the first electronic device and network information of the first electronic device. For example, in FIG. 1B, the server system receives the device identifier “1234” and the network addresses of Device A 122-1 from Device A 122-1.

In some embodiments, the first device identifier of the first electronic device is (704) one of: a media access control address of the first electronic device, a serial number of the first electronic device, or a serial number of a subcomponent of the first electronic device. In some embodiments, the first device identifier of the first electronic device is a subset, less than all, of one of: a media access control address of the first electronic device, a serial number of the first electronic device, or a serial number of a subcomponent of the first electronic device (e.g., the first device identifier is the last four digits of a media access control address of the first electronic device).

In some embodiments, the network information of the first electronic device includes (706) an Internet Protocol address of the first electronic device (e.g., 155.99.25.11 in FIG. 1B.

In some embodiments, the network information of the first electronic device includes (708) a port number of the first electronic device (e.g., 4321 in FIG. 1B).

Subsequent to receiving from the first electronic device the first device identifier of the first electronic device and the network information of the first electronic device, the server system receives (710) from a second electronic device, that is distinct from the first electronic device, a second device identifier of the second electronic device and network information of the second electronic device. The second device identifier is distinct from the first device identifier. For example, in FIG. 1B, the server system receives the device identifier “5678” and the network address of Device B 122-2 from Device B 122-2.

In some embodiments, the second device identifier of the second electronic device is (712) one of: a media access control address of the second electronic device, a serial number of the second electronic device, or a serial number of a subcomponent of the second electronic device. In some embodiments, the second device identifier of the second electronic device is a subset, less than all, of one of: a media access control address of the second electronic device, a serial number of the second electronic device, or a serial number of a subcomponent of the second electronic device (e.g., the second device identifier is the last four digits of a media access control address of the second electronic device).

In some embodiments, the network information of the second electronic device includes (714) an Internet Protocol address of the second electronic device (e.g., 138.76.29.7 in FIG. 1B).

In some embodiments, the network information of the second electronic device includes (716) a port number of the second electronic device (e.g., 9876 in FIG. 1B).

In response to receiving from the second electronic device the second device identifier of the second electronic device and the network information of the second electronic device, the server system determines (718, FIG. 7B) whether the first device identifier is associated with the second device identifier. For example, the server system determines whether the first device identifier (e.g., “1234”) of the first electronic device and the second device identifier (e.g., “5678”) of the second electronic device are included in device association information (e.g., 130-1 in FIG. 1B) for a same peer-to-peer communication group.

In some embodiments, the server system determines (720) whether the first device identifier is associated with the second device identifier based on device association information (e.g., the device association information 130, FIG. 1B).

In some embodiments, the device association information is stored (722) at the server system before any of receiving from the first electronic device the first device identifier of the first electronic device and the network information of the first electronic device and receiving from the second electronic device the second device identifier of the second electronic device and the network information of the second electronic device. For example, as shown in FIG. 6, the device association information is configured and maintained (602) before receiving device information from Device A 122-1 (608) or receiving device information from Device B 122-2 (614). In some embodiments, the device association information for the first electronic device and the second electronic device is stored at the server system before receiving a request (which, in some embodiments, includes the network information of the first electronic device) from the first electronic device for the network information of the second electronic device or receiving a request (which, in some embodiments, includes the network information of the second electronic device) from the second electronic device for the network information of the first electronic device.

In some embodiments, the device association information includes (724) device identifiers for a plurality of groups of electronic devices, each group including two or more device identifiers that correspond to electronic devices that are configured for communication with one another. For example, in FIG. 1A, the device association information includes device association information for a plurality of groups of electronic devices (e.g., device association information 130-1 for a first group of electronic devices and device association information 130-N for an N-th group of electronic devices). The device association information 130-1 includes device identifiers “1234,” and “5678” that correspond to Device A 122-1 and Device B 122-2, and Device A 122-1 and Device B 122-2 are configured for peer-to-peer communication with each other.

In accordance with a determination that the first device identifier is associated with the second device identifier, the server system sends (726, FIG. 7C) to the second electronic device the network information of the first electronic device and/or sends to the first electronic device the network information of the second electronic device. For example, in FIG. 1C, the server system sends the network address of Device B 122-2 to Device A 122-1. In FIG. 1D, the server system sends the network address of Device A 122-1 to Device B 122-2.

In some embodiments, subsequent to receiving from the first electronic device the first device identifier of the first electronic device and the network information of the first electronic device, the server system receives (728) from the first electronic device additional information based on preselected first communication criteria. For example, in FIG. 1C, the server system receives an “alive” message from Device A 122-1. In some embodiments, the preselected first communication criteria include a time interval. For example, the server system periodically receives an “alive” message from Device A 122-1.

In some embodiments, sending to the first electronic device the network information of the second electronic device includes (730), in response to receiving from the first electronic device the additional information based on the preselected first communication criteria, sending to the first electronic device the network information of the second electronic device. For example, in FIG. 1C, the server system sends the network address of Device B 122-2 to Device A 122-1 in response to the “alive” message from Device A 122-1. This is particularly useful when Device A 122-1 is located behind a network address translation (NAT) gateway. When Device A 122-1 is located behind a NAT gateway, the server system may not initiate a network connection with Device A 122-1 for sending the network address of Device B 122-2. However, once the server system receives a message (e.g., an alive message) from Device A 122-1, the server system can respond to the message from Device A 122-1 and include in the response the network address of Device B 122-2.

In some embodiments, the additional information from the first electronic device indicates (732) that the first electronic device is available for communication with the second electronic device.

In some embodiments, the additional information from the first electronic device includes (734) the first device identifier of the first electronic device and the network information of the first electronic device. For example, in FIG. 1C, the alive message from Device A 122-1 includes the device identifier and the network address of Device A 122-1, indicating that the network address of Device A 122-1 remains the same.

In some embodiments, the additional information from the first electronic device includes (736) information obtained using one or more sensors coupled with the first electronic device.

In some embodiments, the information obtained using the one or more sensors includes (738) an image obtained using a camera (e.g., image/video capture device 524, FIG. 5) coupled with the first electronic device.

In some embodiments, subsequent to receiving from the second electronic device the second device identifier of the second electronic device and the network information of the second electronic device, the server system receives (740, FIG. 7D) from the second electronic device additional information based on preselected second communication criteria. For example, in FIG. 1D, the server system receives an “alive” message from Device B 122-2. In some embodiments, the preselected second communication criteria include a time interval. For example, the server system periodically receives an “alive” message from Device B 122-2.

In some embodiments, sending to the second electronic device the network information of the first electronic device includes (742), in response to receiving from the second electronic device the additional information based on the preselected second communication criteria, sending to the second electronic device the network information of the first electronic device. For example, in FIG. 1D, the server system sends the network address of Device A 122-1 to Device B 122-2 in response to the “alive” message from Device B 122-2.

In some embodiments, the additional information indicates (744) that the second electronic device is available for communication with the first electronic device.

In some embodiments, the additional information from the second electronic device includes (746) the second device identifier of the second electronic device and the network information of the second electronic device. For example, in FIG. 1C, the alive message from Device B 122-2 includes the device identifier and the updated network address of Device B 122-2, indicating that the network address of Device B 122-2 has changed.

In some embodiments, the additional information from the second electronic device includes (748) information obtained using one or more sensors coupled with the second electronic device.

In some embodiments, the information obtained using the one or more sensors includes (750) an image obtained using a camera coupled with the second electronic device.

In some embodiments, the server system sends (752, FIG. 7E) to the first electronic device the network information of the second electronic device without sending to the first electronic device the second device identifier of the second electronic device.

In some embodiments, the server system sends (754) to the second electronic device the network information of the first electronic device without sending to the second electronic device the first device identifier of the first electronic device.

In some embodiments, the server system sends (756) to the second electronic device the network information of the first electronic device and/or sends to the first electronic device the network information of the second electronic device so that the first electronic device and the second electronic device establish a peer-to-peer connection. For example, subsequent to the server system sends the network information of the first electronic device and/or the network information of the second electronic device, the first electronic device and the second electronic device establish a peer-to-peer connection with each other, as shown in FIG. 1E.

Some of the features described above with respect to the method 800 are applicable to FIGS. 8A-8C in an analogous manner. Similarly, some of the features described below with respect to FIGS. 8A-8C are applicable to the method 800 in an analogous manner. For brevity, such details are not repeated herein.

FIGS. 8A-8C are flow diagrams illustrating a method 800 of establishing a peer-to-peer connection in accordance with some embodiments. FIGS. 8A-8C correspond to instructions stored in a computer memory or computer readable storage medium (e.g., memory 506, FIG. 5).

The method 800 is performed by an electronic device that includes one or more processors and memory (e.g., electronic device 122, FIG. 5). In FIGS. 8A-8C, the electronic device may be called a first electronic device.

The device sends (802) to a server system a device identifier of the electronic device and network information of the electronic device. For example, in FIG. 1B, Device A 122-1 sends the device identifier “1234” and the network information “155.99.25.11/4321” to the server system.

In some embodiments, the device identifier of the electronic device is (804) one of: a media access control address of the electronic device, a serial number of the electronic device, or a serial number of a subcomponent of the electronic device. In some embodiments, the device identifier of the electronic device is a subset, less than all, of one of: a media access control address of the electronic device, a serial number of the electronic device, or a serial number of a subcomponent of the electronic device.

In some embodiments, the network information of the electronic device includes (806) an Internet Protocol address of the electronic device.

In some embodiments, the network information of the electronic device includes (808) a port number of the electronic device.

Subsequent to sending to the server system the device identifier of the electronic device and the network information of the electronic device, the device receives (810) from the server system network information of a second electronic device. For example, in FIG. 1C, Device A 122-1 receives the network address of Device B 122-2.

In some embodiments, in response to sending to the server system the device identifier of the electronic device and the network information of the electronic device, the device receives from the server system network information of a second electronic device.

In some embodiments, the network information of the second electronic device includes (812) an Internet Protocol address of the second electronic device.

In some embodiments, the network information of the second electronic device includes (814) a port number of the second electronic device.

Subsequent to receiving from the server system network information of the second electronic device, the device sends (816, FIG. 8B) to the second electronic device a request to establish a peer-to-peer connection with the second electronic device, without sending a request to the server system to establish the peer-to-peer connection with the second electronic device. For example, in FIG. 1E, Device A 122-1 sends to Device B 122-2 a request to establish a peer-to-peer connection. As shown in FIG. 1E, Device A 122-1 does not send the request to the server system 102 for establishing a peer-to-peer connection with Device B 122-2.

In some embodiments, the request to establish a peer-to-peer connection with the second electronic device includes the network information of the first electronic device. This allows the second electronic device to compare the network information of the first electronic device, received from the first electronic device, with the network information of the first electronic device, received from the server system for verification purposes.

In some embodiments, the request to establish a peer-to-peer connection with the second electronic device includes a preselected security code. This allows the second electronic device to compare the security code received from the first electronic device with a security stored by the second electronic device for verification purposes.

In some embodiments, in response to receiving from the server system network information of the second electronic device, the device sends (818) to the second electronic device the request to establish the peer-to-peer connection with the second electronic device, without sending a request to the server system to establish the peer-to-peer connection with the second electronic device. For example, Device A 122-1 sends a request to establish a peer-to-peer connection with Device B 122-2 in response to receiving the network information of Device B 122-2 from the server 102.

In some embodiments, the device sends (820) to the second electronic device the request to establish the peer-to-peer connection with the second electronic device without requesting authentication information from the second electronic device or providing authentication information to the second electronic device. For example, the request to establish a peer-to-peer connection does not request an email address, a phone number, or a user password from the second electronic device. This improves protection of the personal information of users participating in a VoIP or video conference call.

In some embodiments, the device detects (822) a user input requesting voice communication with a user of the second electronic device (e.g., user selection of a call icon 304 in FIG. 3A); and, in response to detecting the user input requesting the voice communication with the user of the second electronic device, sends to the second electronic device a request to initiate voice communication. In some embodiments, the voice communication includes a video conference call.

In some embodiments, the user input requesting voice communication includes lifting a handset of a phone. For example, when the device is configured for 1:1 peer-to-peer communication with the second electronic device, it is not necessary and/or possible to select a recipient. Thus, simply lifting the handset sends to the second electronic device a request to initiate voice communication. This is particularly beneficial when there is a need for faster communication with the second electronic device. Because a user of the device does not need to type a name or select a user, a call to the second electronic device can be made faster.

In some embodiments, in response to detecting the user input requesting the voice communication with the user of the second electronic device, the device sends (824) to the second electronic device an image obtained using one or more sensors coupled with the electronic device (e.g., the image 316 in FIG. 3B).

In some embodiments, the device establishes (826, FIG. 8C) the peer-to-peer connection with the second electronic device. In some embodiments, the peer-to-peer connection is a TCP connection or a UDP session between the electronic device and the second electronic device. The peer-to-peer connection between the electronic device and the second electronic device does not include passing TCP packets or UDP datagrams through the server system.

In some embodiments, the device sends (828) to the second electronic device one or more images obtained using one or more sensors coupled with the electronic device in accordance with preselected communication timing criteria (e.g., preselected time interval). For example, the device sends a stream of images to the second electronic device so that the second electronic device can monitor events around the electronic device. This takes advantage of the nature of a peer-to-peer communication between the electronic device and the second electronic device. Because the peer-to-peer communication between the electronic device and the second electronic device, once established, does not rely on the server system 102, the peer-to-peer communication between the electronic device and the second electronic device can continue regardless of operational issues in the server system (e.g., a power-loss or a network traffic jam of the server system). Thus, the peer-to-peer communication between the electronic device and the second electronic device is more robust and reliable than communicating through the server system. In addition, the peer-to-peer communication relieves the server system from an overhead associated with relaying data packets to and from electronic devices, thereby improving efficiency and reducing power consumption by the server system. Furthermore, when the electronic device is coupled with a special camera (e.g., an infrared camera), the peer-to-peer communication between the electronic device and the second electronic device can be used for special purposes, such as security or industrial purposes, which require higher reliability and continuity.

In some embodiments, the device sends to the second electronic device data obtained using one or more sensors coupled with the electronic device (e.g., a temperature, a carbon-monoxide level, a carbon-dioxide level, air quality, a radiation level, motion information, etc.). In some embodiments, the device sends to the server system data obtained using one or more sensors coupled with the electronic device. In some embodiments, the device sends to the server system data obtained using one or more sensors coupled with the electronic device as part of an “alive” message.

In some embodiments, subsequent to receiving from the server system the network information of the second electronic device, the device receives (830) from the server system additional information. The additional information includes updated network information of the second electronic device. Subsequent to receiving from the server system the additional information, the device receives from the second electronic device a request to initiate voice communication; determines whether the updated network information of the second electronic device is distinct from the network information of the second electronic device; and, in accordance with a determination that the updated network information of the second electronic device is distinct from the network information of the second electronic device, outputs an indication that the updated network information of the second electronic device is distinct from the network information of the second electronic device (e.g., displays a message, and/or output an audible signal, indicating that the network information of the second electronic device has changed). For example, in FIG. 1C, Device A 122-1 receives an updated network address of Device B 122-2. When Device A 122-1 receives a request to establish a peer-to-peer communication (e.g., voice communication using the peer-to-peer communication) from Device B 122-2, Device A 122-1 displays an indication that the network information of Device B 122-2 has changed.

In some embodiments, subsequent to receiving from the server system the network information of the second electronic device, the device receives from the second electronic device a request to establish a peer-to-peer connection with the second electronic device. The request from the second electronic device includes network information of the second electronic device. The device compares the network information of the second electronic device received from the second electronic device with the network information of the second electronic device received from the server system. The device determines whether the network information of the second electronic device received from the second electronic device matches the network information of the second electronic device received from the server system. In accordance with a determination that the network information of the second electronic device received from the second electronic device matches the network information of the second electronic device received from the server system, the device accepts the request to establish a peer-to-peer connection with the second electronic device (or sends an acceptance message to the second electronic device). In some embodiments, in accordance with a determination that the network information of the second electronic device received from the second electronic device does not match the network information of the second electronic device received from the server system, the device disregards the request to establish a peer-to-peer connection with the second electronic device (or sends a denial message to the second electronic device).

In some embodiments, subsequent to receiving from the server system the network information of the second electronic device, the device receives from the second electronic device a request to establish a peer-to-peer connection with the second electronic device. The request from the second electronic device includes a security code. The device compares the security code received from the second electronic device with a preselected security code. The device determines whether the security code from the second electronic device matches the preselected security code. In accordance with a determination that the security code from the second electronic device matches the preselected security code, the device accepts the request to establish a peer-to-peer connection with the second electronic device (or sends an acceptance message to the second electronic device). In some embodiments, in accordance with a determination that the security code from the second electronic device does not match the preselected security code, the device disregards the request to establish a peer-to-peer connection with the second electronic device (or sends a denial message to the second electronic device).

The foregoing description, for purpose of explanation, has been described with reference to specific embodiments. However, the illustrative discussions above are not intended to be exhaustive or to limit the scope of claims to the precise forms disclosed. Many modifications and variations are possible in view of the above teachings. The embodiments were chosen and described in order to best explain the underlying principles and their practical applications, to thereby enable others skilled in the art to best utilize the described principles and various embodiments with various modifications as are suited to the particular use contemplated.

For example, in accordance with some embodiments, a method performed at an electronic device that includes one or more processors and memory includes, while in a standby mode, storing network information of a second electronic device; and, detecting a user input requesting voice communication with a user of the second electronic device. The method also includes, in response to detecting the user input requesting the voice communication with the user of the second electronic device, sending to the second electronic device a request to initiate voice communication.

What is claimed is:

1. A method, comprising:
at a server system that includes one or more processors and memory:
receiving from a first electronic device a first device identifier of the first electronic device and network information of the first electronic device;
subsequent to receiving from the first electronic device the first device identifier of the first electronic device and the network information of the first electronic device, receiving from a second electronic device, that is distinct from the first electronic device, a second device identifier of the second electronic device and network information of the second electronic device, wherein the second device identifier is distinct from the first device identifier;
in response to receiving from the second electronic device the second device identifier of the second electronic device and the network information of the second electronic device, determining whether the first device identifier is associated with the second device identifier; and,
in accordance with a determination that the first device identifier is associated with the second device identifier, sending to the second electronic device the network information of the first electronic device and/or sending to the first electronic device the network information of the second electronic device.

2. The method of claim 1, including determining whether the first device identifier is associated with the second device identifier based on device association information, wherein the device association information is stored at the server system before any of receiving from the first electronic device the first device identifier of the first electronic device and the network information of the first electronic device and receiving from the second electronic device the second device identifier of the second electronic device and the network information of the second electronic device.

3. The method of claim 2, wherein the device association information includes device identifiers for a plurality of groups of electronic devices, each group including two or more device identifiers that correspond to electronic devices that are configured for communication with one another.

4. The method of claim 1, including, subsequent to receiving from the first electronic device the first device identifier of the first electronic device and the network information of the first electronic device, receiving from the first electronic device additional information based on preselected first communication criteria.

5. The method of claim 4, wherein sending to the first electronic device the network information of the second electronic device includes, in response to receiving from the first electronic device the additional information based on the preselected first communication criteria, sending to the first electronic device the network information of the second electronic device.

6. The method of claim 4, wherein the additional information from the first electronic device indicates that the first electronic device is available for communication with the second electronic device.

7. The method of claim 4, wherein the additional information from the first electronic device includes the first device identifier of the first electronic device and the network information of the first electronic device.

8. The method of claim 4, wherein the additional information from the first electronic device includes information obtained using one or more sensors coupled with the first electronic device.

9. The method of claim 8, wherein the information obtained using the one or more sensors include an image obtained using a camera coupled with the first electronic device.

10. The method of claim 1, including, subsequent to receiving from the second electronic device the second device identifier of the second electronic device and the network information of the second electronic device, receiving from the second electronic device additional information based on preselected second communication criteria.

11. The method of claim 10, wherein sending to the second electronic device the network information of the first electronic device includes, in response to receiving from the second electronic device the additional information based on the preselected second communication criteria, sending to the second electronic device the network information of the first electronic device.

12. The method of claim 10, wherein the additional information indicates that the second electronic device is available for communication with the first electronic device.

13. The method of claim 10, wherein the additional information from the second electronic device includes the second device identifier of the second electronic device and the network information of the second electronic device.

14. The method of claim 10, wherein the additional information from the second electronic device includes information obtained using one or more sensors coupled with the second electronic device.

15. The method of claim 14, wherein the information obtained using the one or more sensors include an image obtained using a camera coupled with the second electronic device.

16. The method of claim 1, wherein the first device identifier of the first electronic device is one of: a media access control address of the first electronic device, a serial number of the first electronic device, or a serial number of a subcomponent of the first electronic device, and the second device identifier of the second electronic device is one of: a media access control address of the second electronic device, a serial number of the second electronic device, or a serial number of a subcomponent of the second electronic device.

17. The method of claim 1, including sending to the first electronic device the network information of the second electronic device without sending to the first electronic device the second device identifier of the second electronic device and sending to the second electronic device the network information of the first electronic device without sending to the second electronic device the first device identifier of the first electronic device.

18. The method of claim 1, including sending to the second electronic device the network information of the first electronic device and/or sending to the first electronic device the network information of the second electronic device so that the first electronic device and the second electronic device establish a peer-to-peer connection.

19. A server system, comprising:
one or more processors; and
memory storing one or more programs for execution by the one or more processors, the one or more programs including instructions for:
receiving from a first electronic device a first device identifier of the first electronic device and network information of the first electronic device;
subsequent to receiving from the first electronic device the first device identifier of the first electronic device and the network information of the first electronic device, receiving from a second electronic device, that is distinct from the first electronic device, a second device identifier of the second electronic device and network information of the second electronic device, wherein the second device identifier is distinct from the first device identifier; and,
in response to receiving from the second electronic device the second device identifier of the second electronic device and the network information of the second electronic device, determining whether the first device identifier is associated with the second device identifier; and,
in accordance with a determination that the first device identifier is associated with the second device identifier, sending to the second electronic device the network information of the first electronic device and/or sending to the first electronic device the network information of the second electronic device.

20. A non-transitory computer readable storage device, storing:
one or more programs for execution by a server system, the one or more programs including instructions for:
receiving from a first electronic device a first device identifier of the first electronic device and network information of the first electronic device;
subsequent to receiving from the first electronic device the first device identifier of the first electronic device and the network information of the first electronic device, receiving from a second electronic device, that is distinct from the first electronic device, a second device identifier of the second electronic device and network information of the second electronic device, wherein the second device identifier is distinct from the first device identifier;
in response to receiving from the second electronic device the second device identifier of the second electronic device and the network information of the second electronic device, determining whether the first device identifier is associated with the second device identifier; and,
in accordance with a determination that the first device identifier is associated with the second device identifier, sending to the second electronic device the network information of the first electronic device and/or sending to the first electronic device the network information of the second electronic device.
